(19) United States
(12) Patent Application Publication
(10) Pub. No.: US 2020/0369246 A1
(43) Pub. Date: Nov. 26, 2020

(54) ELECTROHYDRAULIC VEHICLE POWER BRAKE SYSTEM FOR AN AUTONOMOUSLY DRIVING LAND VEHICLE

(71) Applicant: Robert Bosch GmbH, Stuttgart (DE)

(72) Inventors: Mirko Brand, Grossbottwar (DE); Bernhard Maier, Flein (DE); Stefan Strengert, Stuttgart (DE)

(21) Appl. No.: 16/858,220

(22) Filed: Apr. 24, 2020

(30) Foreign Application Priority Data
May 25, 2019 (DE) 102019207685.8

(51) Int. Cl. B60T 7/12; B60T 8/17; B60T 13/68; B60T 13/14; B60T 13/20; B60T 13/16; B60T 13/62

(52) U.S. Cl. CPC B60T 7/12; B60T 8/17; B60T 13/686; B60T 13/141; B60T 2270/403; B60T 13/167; B60T 13/62; B60T 2270/402; B60T 2270/413; B60T 13/20

(57) ABSTRACT

An electrohydraulic vehicle power brake system for a motor vehicle driving autonomously on public roads. A power brake pressure generator of the vehicle power brake system having two hydraulically parallel power valves is connected to the vehicle brake system and the two power valves are controlled using two redundant electronic control units.

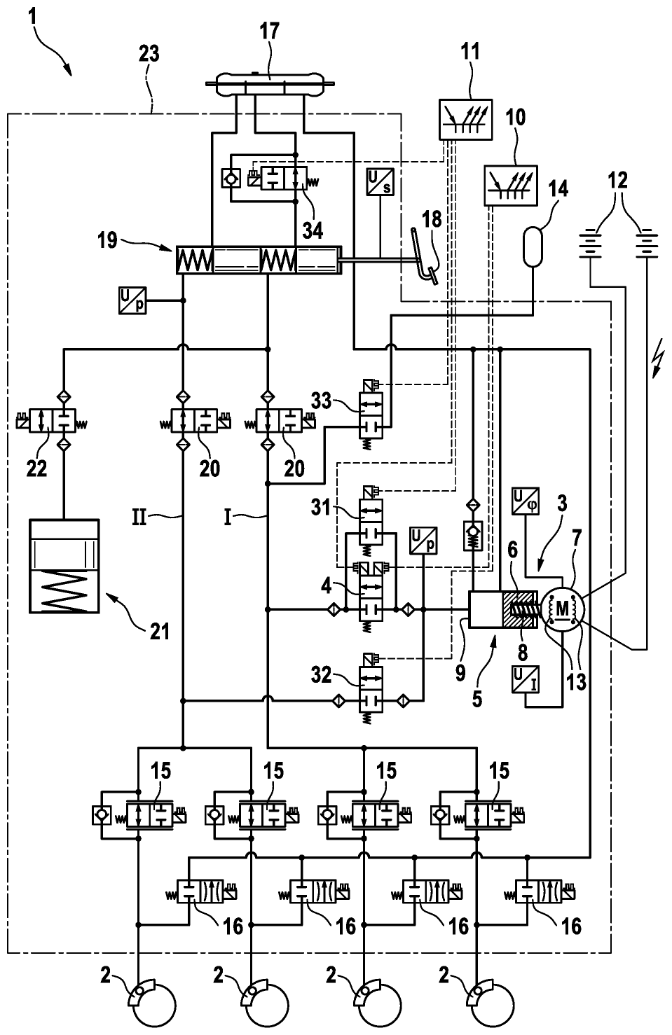

### CROSS REFERENCE

The present application claims the benefit under 35 U.S.C. § 119 of German Patent Application No. DE 102019207685.8 filed on May 25, 2019, which is expressly incorporated herein by reference in its entirety.

### FIELD

The present invention relates to an electrohydraulic vehicle power brake system for a land vehicle driving on public roads autonomously up to level 4 or level 5. The designation “autonomously driving” refers to the possibility of driving autonomously, it also being possible however to use the vehicle brake system according to the present invention for land vehicles that are not driving autonomously or that are driving autonomously at a lower level.

### BACKGROUND INFORMATION

For autonomous driving up to level 4 (driver may be prompted to intervene) and level 5 (highest level; no driver required), a vehicle power brake system having redundancies is required, which excludes a complete failure of the vehicle brake system with a probability bordering on certainty, without requiring an intervention by a driver.

German Patent Application No. DE 10 2014 220 440 A1 describes an electrohydraulic vehicle power brake system having two brake units, each of which have respectively one power brake pressure generator having an electrically controllable pressure source and a brake pressure control valve system for each wheel brake. One brake unit is connected to the other brake unit and hydraulic wheel brakes are connected to the one brake unit so that the wheel brakes are able to be operated by the one brake unit and through the one brake unit are able to be operated by the other brake unit. In this manner, in the event of a malfunction or a failure of one brake unit, the wheel brakes are able to be operated by the other brake unit without driver intervention. The respectively active brake unit controls the wheel brake pressures in the wheel brakes.

### SUMMARY

An example electrohydraulic vehicle power brake system according to the present invention is provided for autonomous driving up to levels 4 and 5 on public roads. Level 4 is also referred to as highly automated driving and it signifies that control of a vehicle is taken over permanently by an electronic system and a driver is prompted to intervene only when the system is no longer coping with the driving tasks. Level 5 is also referred to as full automation and requires no driver. The vehicle brake system according to the present invention, however, may also be used for lower levels and for non-autonomous driving.

The example electrohydraulic vehicle power brake system has a power brake pressure generator, to which one or multiple hydraulic wheel brakes are connected via two power valves that are hydraulically connected to each other in parallel. In a multi-circuit vehicle brake system, one brake circuit is connected to the power brake pressure generator via the two power valves hydraulically connected in parallel. One or multiple further brake circuits may be connected to the power brake pressure generator via respectively one or also via respectively two power valves hydraulically connected in parallel. It is also conceivable to have the wheel brakes and/or one or multiple brake circuits connected to the power brake pressure generator via more than two power valves hydraulically connected in parallel.

Alternatively and additionally, one or multiple power valves may have independent operating devices, for example two solenoids.

The electrohydraulic vehicle power brake system furthermore has at least two electronic control units for redundantly controlling the vehicle brake system. Controlling is to be understood as also comprising regulation. “Controlling” signifies in particular controlling electrical components of the vehicle brake system such as an electric motor of the power brake pressure generator and/or controlling electrohydraulic components such as solenoid valves. “Redundant” signifies that the vehicle brake system is able to be operated by each of the two electronic control units, even if one control unit is possibly only able to perform a limited auxiliary braking action using for example only a sub-set of the wheel brakes of the vehicle brake system, a slower brake pressure buildup and/or a lower brake force. A power service brake action is possible using one of the two control units or using both control units jointly. More than two control units are also possible.

With little effort, the present invention increases an availability of the vehicle power brake system. In particular, it is possible to implement the present invention with slight modifications of conventional hydraulic vehicle power brake systems.

The power valves are in particular solenoid valves, which are here referred to as power valves for clear reference.

Advantageous embodiments and refinements of the present invention are described herein.

An example vehicle power brake system according to the present invention preferably has two or more redundant current sources, in particular storage batteries in order to ensure a current supply of the electronic control units and of the electrohydraulic and electrical components of the vehicle brake system. Each current source is to enable the operation of at least one electronic control unit and at least some of the components of the vehicle brake system, by which the vehicle brake system is able to be operated, even if possibly only with a limited auxiliary braking action.

To increase the availability of the power brake pressure generator, an example embodiment of the present invention provides an electric motor having two or more windings or winding sets, by which the electric motor is operable independently, for driving the power brake pressure generator. “Operable independently” means that the electric motor is able to be operated by applying current to any of the windings or winding sets.

In another example embodiment of the present invention, an alternative is to provide a second power brake pressure source, by which the vehicle brake system is able to be operated in the event of a failure of the power brake pressure generator. The second power brake pressure source may have a pressure reservoir for example, by which the vehicle brake system is able to be operated once or preferably multiple times. The second power brake pressure source may for example also have a power brake pressure generator having for example an electromotively drivable hydraulic pump or an electromechanically drivable piston-cylinder unit. The second power brake pressure source does not exclude an electric motor having two or more windings or winding sets.

All of the features described herein and shown in the FIGURE may be realized individually by themselves or in fundamentally any combination in exemplary embodiments of the present invention. Embodiments of the present invention, which do not include all, but only one or multiple features, are fundamentally possible.

### BRIEF DESCRIPTION OF THE DRAWING

The present invention is explained in greater detail below on the basis of one specific embodiment shown in the FIGURE.

The FIGURE shows a hydraulic circuit diagram of an electrohydraulic vehicle power brake system according to the present invention.

### DETAILED DESCRIPTION OF EXAMPLE EMBODIMENTS

An example electrohydraulic vehicle power brake system 1 according to the present invention shown in the FIGURE is provided for a land vehicle, namely a passenger motor vehicle, driving autonomously up to level 4 or 5 on public roads. Level 4 designates autonomous driving, in which a driver may be prompted to intervene, and level 5, the highest level, designates autonomous driving that requires no driver intervention. Lower levels and non-autonomous driving are likewise possible.

The example vehicle brake system 1 according to the present invention is designed as a two-circuit vehicle brake system having four hydraulic wheel brakes 2, of which respectively two are connected to one of the two brake circuits I, II.

Vehicle brake system 1 has a power brake pressure generator 3, to which the two brake circuits I, II are connected via solenoid valve valves, which are here designated as power valves 4, 31, 32. A first brake circuit I, which may also be understood as the primary circuit, is connected to power brake pressure generator 3 via first power valve 4 and a second power valve 31, which is hydraulically connected in parallel to first power valve 4, so that a brake pressure from power brake pressure generator 3 may be applied to first brake circuit I selectively via the first, the second or via both power valves 4, 31. The other, second brake circuit II, which may also be understood as a secondary circuit, is connected to power brake pressure generator 3 via another power valve 32.

Alternatively, it is possible for first power valve 4, via which first brake circuit I is connected to power brake pressure generator 3, to have two solenoids so that in the event of a failure of one solenoid, the other solenoid is able to take over the switching function. It is possible in this case (but not necessary) to eliminate second power valve 31.

In the illustrated and described specific embodiment of the present invention, the first power brake pressure generator 3 has a piston-cylinder unit 5, whose piston 6 for generating a brake pressure is axially displaceable in a cylinder 9 by an electric motor 7 via a screw drive 8 or another rotation-translation conversion gear. Piston-cylinder unit 5 may also be referred to as a plunger unit and piston 6 as a plunger piston.

Vehicle brake system 1 has two electronic control units 10, 11 for redundantly controlling vehicle brake system 1, controlling being understood to include regulation as well. “Controlling the vehicle brake system 1” is intended to mean controlling electrohydraulic components such as solenoid valves, electrical components such as electric motor 7 and other possible components of vehicle brake system 1. “Redundantly” means controlling the components selectively using one of the two control units 10, 11 so that in the event of a failure of one of the two control units 10, 11, the vehicle brake system 1 is able to be controlled by the other control unit 11, 10. It suffices if a limited auxiliary braking action using a second of the two control units 11 is possible in the event of the failure of a first of the two control units 10. For a service braking action, vehicle brake system 1 is controlled by first control unit 10 or by both control units 10, 11 jointly. A limited auxiliary braking action may mean for example an application of pressure only to one of the two brake circuits I and thus an operation only of the wheel brakes connected to this brake circuit or a slower buildup of brake pressure.

For the purpose of controlling and in particular regulating, the two electronic control units 10, 11 receive signals from sensors of vehicle brake system 1 such as pressure sensors, wheel rotation sensors, an angle-of-rotation sensor and a current sensor of electric motor 7 of power brake pressure generator 7, the two control units 10, 11 being able to receive signals from all sensors or signals from selected sensors.

For the purpose of increasing its availability, vehicle brake system 1 has two storage batteries as redundant current sources 12, each control unit 10, 11 being connected to one of the two current sources 12.

Electric motor 7 of power brake pressure generator 3 has two windings 13, each of which is connected to one of the two current sources 12. Electric motor 7 is able to be operated by each of the two windings 13 independently of the other winding 13.

Electric motor 7 is selectively controlled by each of the two control units 10, 11. The first and the additional power valve 4, 32, by which the two brake circuits I, II are connected to power brake pressure generator 3, are controlled by first control unit 10. The second power valve 31, which is hydraulically connected in parallel to first power valve 4 and through which first brake circuit I is additionally connected to power brake pressure generator 3, is controlled by second control unit 10 so that in the event of a failure of first control unit 10 and/or of one of power valves 4, 31, 32, first brake circuit I is still operable. If first power valve 4 has two solenoids, one solenoid is controlled by first control unit 10 and the second solenoid is controlled by second control unit 11.

A fourth power valve 33 connects one brake circuit, first brake circuit I in the exemplary embodiment, to a hydraulic accumulator as power brake pressure source 14, which contains pressurized brake fluid and which may be pressurized for example by power brake pressure generator 3. In the event of a failure of power brake pressure generator 3, power brake pressure source 14 preferably allows for multiple braking actions. In place of the hydraulic accumulator, power brake pressure source 14 may also have a hydraulic pump for example, which is drivable by an electric motor, or a piston-cylinder unit such as power brake pressure generator 3 (not shown). Power brake pressure source 14 may also be a power brake pressure generator. It is denoted as power brake pressure source 14 because it is not operated by muscle power, but rather by external energy. In the exemplary embodiment, fourth power valve 33 is controlled by second control unit 11 so that in the event of a failure of first control unit 10, wheel brakes 2 connected to first brake circuit I, which are controlled by brake pressure from power brake pressure source 14, are operable by second control unit 11. Power brake pressure source 14 makes second winding 13 of electric motor 7 of power brake pressure generator 3 dispensable.

Each wheel brake 2 has an intake valve 15, through which it is connected to the respective brake circuit I, II, and a discharge valve 16, through which wheel brakes 2 are connected to a non-pressurized brake fluid reservoir 17. The intake valves 15 and the discharge valves 16 form a brake pressure control valve system, which makes it possible to control the wheel brake pressures in each wheel brake 2 individually. In conjunction with power brake pressure generator 3, slip control systems, in particular lock-up protection, traction slip and/or driving dynamics control systems or an electronic stability program are possible. These slip control systems are commonly designated by the abbreviations ABS, ASR and/or FDR or ESP. Driving dynamics control systems and electronic stability programs are colloquially also called skid protection control systems. Such slip control systems are conventional and are not explained further here.

Vehicle brake system 1 according to the present invention has a two-circuit master brake cylinder 19 operable by a brake pedal 18, to which the two brake circuits I, II are connected via respectively one separating valve 20. A service braking action occurs as a power braking action using power brake pressure generator 3, for the purpose of which the first and the additional power valves 4, 32 are opened. Separating valves 20 are closed and master brake cylinder 19 is thereby hydraulically separated from brake circuits I, II.

In a non-autonomous driving operation, master brake cylinder 19 acts as a setpoint device for a brake pressure to be generated or to be controlled. So that brake fluid may be displaced from master brake cylinder 19 and brake pedal 18 may be moved while separating valves 20 are closed, a pedal travel simulator 21 is connected to master brake cylinder 19 via a simulator valve 22, in one of the two brake circuits, in the first brake circuit I in the exemplary embodiment. Pedal travel simulator 21 is a spring-loaded hydraulic store. In the event of a failure of power brake pressure generator 3, vehicle brake system 1 may also be operated using master brake cylinder 19 in a driver operation.

Master brake cylinder 19 is connected to nonpressurized brake fluid reservoir 17, a reservoir valve 34 being situated between brake fluid reservoir 17 and master brake cylinder 19 in one of the two brake circuits, in first brake circuit I in the exemplary embodiment.

In the described and illustrated specific embodiment of the present invention, valves 4, 15, 16, 20, 21 31, 32, 33, 34 are 2/2-way solenoid valves, it also being possible for intake valves 15 and discharge valves 16 to be combined into 3/3-way solenoid valves (not shown). In the exemplary embodiment, power valves 4, 31, 32, 33, discharge valves 16, separating valves 20 and simulator valve 20 are closed in their currentless basic positions, and intake valves 15, separating valves 20 and reservoir valve 34 are open in their currentless basic positions.

The first and the additional power valve 4, 32, intake valves 15, discharge valves 16, separating valves 20 and simulator valve 22 are controlled by first electronic control unit 10, and second and fourth power valves 31, 33 and reservoir valve 34 are controlled by second electronic control unit 11.

With the exception of brake fluid reservoir 17, wheel brakes 2, control units 10, 11, current sources 12 and power brake pressure source 14, the components of vehicle brake system 1 are accommodated in a hydraulic block 23. Hydraulic block 23 is a rectangular parallelepiped-shaped metal block, which has bores as receptacles for the components of vehicle brake system 1. The receptacles for the components are connected to one another by a system of bore holes in hydraulic block 23 in accordance with the hydraulic circuit layout. Equipped with the components, hydraulic block 23 forms a hydraulic unit of vehicle brake system 1. Wheel brakes 2 are connected to hydraulic block 23 via brake lines, and brake fluid reservoir 17 is situated on hydraulic block 23. It is also possible, however, for brake fluid reservoir 23 to be situated in another location and to be connected to the hydraulic block via brake fluid lines. Power brake pressure source 14 is likewise connected to hydraulic block 23 via a brake line. It may also be situated on hydraulic block 23, however, or, if there is sufficient space, in hydraulic block 23. Hydraulic block 23 only needs to be modified for receiving second power valve 31 and, if present, for receiving fourth power valve 33 and the connection of power brake pressure source 14.

The two control units 10, 11 are electrically insulated from each other, are spatially and galvanically separated from each other, and are situated in fluid-tight fashion on different sides of hydraulic block 23.

What is claimed is:

1. An electrohydraulic vehicle power brake system for a land vehicle driving autonomously on public roads, comprising:
a power brake pressure generator to which a hydraulic wheel brake is connected via a first power valve;
a first electronic control unit configured to control the vehicle power brake system;
(i) a second power valve is hydraulically connected in parallel to the first power valve and/or (ii) the first power valve has two independent actuating devices; and
a second electronic control unit configured to redundantly control the vehicle brake system relative to the first electronic control unit.

2. The electrohydraulic vehicle power brake system as recited in claim 1, wherein the vehicle power brake system includes two redundant current sources.

3. The electrohydraulic vehicle power brake system as recited in claim 1, wherein the vehicle power brake system includes the second power valve, the first power valve is controlled by the first electronic control unit, and the second power valve is controlled by the second electronic control unit.

4. The electrohydraulic vehicle power brake system as recited in claim 1, wherein the vehicle power brake system includes the second power valve, the second power valve is controlled by the second electronic control unit, and all other electrohydraulic components of the vehicle brake system are controlled by the first electronic control unit, and the power brake pressure generator is alternatively controlled by the first electronic control unit or by the second electronic control unit.

5. The electrohydraulic vehicle power brake system as recited in claim 1, further comprising:
a brake fluid reservoir which is connected to the vehicle brake system via a reservoir valve, which is controlled by the second electronic control unit.

6. The electrohydraulic vehicle power brake system as recited in claim 1, wherein the power brake pressure generator has an electric motor having two windings which are configured to operate the electric motor independently of one another.

7. The electrohydraulic vehicle power brake system as recited in claim 1, wherein the vehicle brake system has a second power brake pressure source in addition to the power brake pressure generator.

8. The electrohydraulic vehicle power brake system as recited in claim 1, wherein the first and second electronic control units are electrically insulated from each other and/or are galvanically separated from one another and/or are individually fluid-tight.

9. The electrohydraulic vehicle power brake system as recited in claim 1, further comprising:
a brake pressure control valve system for controlling wheel brake pressures in wheel brakes of the vehicle.

10. The electrohydraulic vehicle power brake system as recited in claim 1, further comprising:
a master brake cylinder by which wheel brakes of the vehicle are operated.
